(19) United States
(12) Patent Application Publication
(10) Pub. No.: US 2013/0193346 A1
(43) Pub. Date: Aug. 1, 2013

(54) Method for Identifying an Object

(71) Applicants: Thomas Jüstel, Witten (DE); Dominik Uhlich, Steinfurt (DE); Helga Bettentrup, Steinfurt (DE); Alex Deitermann, Osnabruck (DE); Sebastian Rütter, Munster (DE)

(72) Inventors: Thomas Jüstel, Witten (DE); Dominik Uhlich, Steinfurt (DE); Helga Bettentrup, Steinfurt (DE); Alex Deitermann, Osnabruck (DE); Sebastian Rütter, Munster (DE)

(73) Assignee: TAILORLUX GMBH, Munster (DE)

(21) Appl. No.: 13/578,285

(22) PCT Filed: Feb. 9, 2011
(86) PCT No.: PCT/DE2011/075015

§ 371 Date: Nov. 19, 2012

(30) Foreign Application Priority Data
Feb. 10, 2010 (DE) 10 2010 007 566.3

(51) Int. Cl. G01N 21/64; C09K 11/08

(52) U.S. Cl. CPC G01N 21/64; C09K 11/08
USPC 250/459.1; 252/301.36; 250/458.1; 250/216

(57) ABSTRACT

The invention relates to a method for identifying an object, wherein said object has a security element, which contains one or more inorganic luminescent pigments, wherein the method comprises the steps of producing an emission spectrum of the luminescent pigment and comparing the obtained emission spectrum with the spectrum specified for the security element. The invention further relates to a security element, by means of which it is possible to determine the authenticity of a product in a simple manner.

The present invention concerns a method for identifying an object, wherein this object comprises a security element which contains one or several inorganic luminescent pigments, as well as a security element and a device for identifying an object.

As a protection against imitation or reproduction of information carriers, e.g., by color copiers or other reproduction methods, they are equipped with security elements, as for example, a watermark or moire structures, which are not copied upon reproduction or only insufficiently so that a forgery can be distinguished from the original.

The protection of information carriers and brand products of all kinds becomes more and more important. For example, the WHO estimates that trade with piracy products reached a level of 300 billion Euros in 2007. The frequency of cases in which pharmaceuticals or safety-relevant vehicle parts are faked increases also, and this not only causes damage to the manufacturers of the brand products but also creates a danger potential to the customer or consumer.

An even greater forgery protection can be achieved when the security element consists of a photonic or luminescent material whose color or luminescence depends on the viewing angle or the irradiation situation, or consists of an embossed structure which can be detected haptically.

WO 2009/071167 discloses an optical security element on the base of anisotropic pigments which comprises an intrinsic concealed and/or forensic security element and is comprised of a transparent inorganic matrix and at least one particulate material embedded in this matrix and being different from this matrix. The embedded particulate material absorbs, reflects and/or emits selectively or non-selectively visible light under the effect of electromagnetic radiation.

The use of luminescent compounds or pigments for the authenticity protection of a document of value has also been known for some time. Thus, disclosed in DE 198 04 032 is a printed document of value with at least one authenticity feature in the form of a luminescent substance on the basis of a host lattice, doped with at least one rare earth metal, that absorbs essentially in the visible spectrum, is thus capable of being excited in the visible spectrum and is transparent at least in partial areas of the IR spectral range. As a rare earth element holmium is used.

Luminescent pigments make available a multitude of possibilities to serve as a security element on account of the fact that the luminescence intensity as well as the spectral energy distribution depends on the excitation energy, the temperature, the pressure, the defect density and on the point in time of the measurement after the end of the excitation. In this context, a security feature based on a luminescent substance can be concealed or open.

The use of the time-dependent intensity as a security feature is described, e.g., in EP 1 237 128, Security elements on the basis of luminescent materials contain in almost all cases soluble organic luminescent substances because these can be easily processed to inks or lacquers and are therefore easily applied or introduced, as described, for example, in US 2007/051929 and WO 2004/081125, However, the problem of most organic luminescent substances is their low stability, in particular with respect to higher temperatures and irradiation with blue light or UV radiation, and sometimes also their toxicological risk. Besides, organic luminescent substances can be easily faked, because with knowledge of the structural formula the spectrum of the substance is unique and is also computable for example by means of modern software.

EP 1 241 021 discloses a document of value and/or security document for high-speed verification which contains up-conversion elements in the form of small inorganic particles that are applied so near to the surface on the document of value and/or security document that a high-speed verification is performed by means of NIR radiation and detection of the emission spectra in the visible and MR range of the electromagnetic spectrum. As an up-conversion element, a thulium-activated and ytterbium-codoped gadolinium oxisulfide of the composition (Gd_{1-x-y}YbₓTmₓ)₂O₂S or (Gd_{1-x-y})₂O₂S:Ybₓ, Tm_{y} is used.

The security documents known in the prior art have the disadvantage that even though it is possible with the elements contained therein to prove whether this special compound is present or not, nevertheless, no proof can be produced whether the examined document is truly originating from a certain manufacturer.

Therefore, the object of the invention is to make available an open or concealed security element of the aforementioned kind which avoids the disadvantages of the known security elements, i,e. provides an increased level of protection against forgery, is ecologically safe, has a high stability and can be checked at the same time in an easy way with regard to its authenticity. Furthermore, it is an object of the present invention to make available a method for identifying an object with which the authenticity of this object can be proved.

The subject matter of the present invention is a method for identifying an object, wherein the object has a security element which contains one or several inorganic luminescent pigments, and wherein the method comprises the steps of:
generating an emission spectrum of the luminescent pigment,
comparing the obtained emission spectrum with the spectrum predetermined for the luminescent pigment.

With the method according to the invention it is possible to distinguish pirated copies or imitations of products or information carriers of any kind, constitution or use from the original. This is based in particular on the use of one or several luminescent pigments which are contained in this security element. The method can be used for detecting either structure-less or structured pigmentation of products of any kind, constitution or use, as for example plastics, building materials, rubber materials, color varnishes, raw paper materials, specialty glasses, explosives and adhesives, or for surface coating of banknotes, securities, credit cards or cash cards, identification cards, passports, charge cards, documents, stamps, tickets, CDs, DVDs, packaging, synthetic fibers and natural fibers, fabrics and laid fabrics (nonwovens), wood, surface coatings, ceramics, plants and animals as well as products made therefrom, including fibers, leather, fabrics and nonwovens, pharmaceutical products and similar things. For identifying an object or product by using the method according to the invention, this object contains a security element which contains one or several inorganic luminescent pigments.

The term security element can also mean within the scope of this invention that the security element is comprised exclusively of one or several inorganic luminescent pigments.

The object to be identified can be a product of any kind, constitution or use, as already mentioned above. As a function of the kind, constitution and intended purpose, the security element can be incorporated immediately into this object, for example, can be admixed to the starting materials. It is also possible to apply the security element in the form of a printed element; all relevant printing methods, like planographic printing, gravure printing, relief printing and screen printing, silk screen printing, gas phase deposition, color application methods, lacquering methods, varnish applications, paint applications, and ink applications are possible in this context.

The security element used in the method according to the invention contains at least one inorganic luminescent pigment or is comprised thereof, wherein the emission spectrum of the pigment is such that it essentially represents the fingerprint of the product to be identified. The luminescent pigment has preferably a mean particle size of 1 nm to 1,000 μm, preferably from 1 nm to 100 μm and in particular from 10 nm to 10 μm. It is particularly preferred that the particles are present as nearly spherical particles. In a preferred embodiment, the luminescent pigment is an inorganic solid state compound which either is self-activated, i.e., exhibits donor acceptor luminescence or charge transfer luminescence (intrinsic luminescence), or is activated with one or several luminescent ions from the group of In⁺, Sn²⁺, Pb²⁺, Sb³⁺, Bi³⁺, Ce³⁺, Ce⁴⁺, Pr³⁺, Nd³⁺, Sm²⁺, Sm³⁺, Eu²⁺, Eu³⁺, Gd³⁺, Tb³⁺, Dy³⁺, Ho³⁺, Er³⁺, Tm²⁺, Tm³⁺, Yb²⁺, Yb³⁺, Ti³⁺, V²⁺, V³⁺, V⁴⁺, Cr³⁺, Mn²⁺, Mn³⁺, Mn⁴⁺, Fe³⁺, Fe⁴⁺, Fe⁵⁺, Co³⁺, Co⁴⁺, Ni²⁺, Cu⁺, Ru²⁺, Ru³⁺, Pd²⁺, Ag⁺, Ir³⁺, Pt ²⁺ and Au⁺ (extrinsic luminescence).

The inorganic solid state compound is a binary, ternary or quaternary halogenide, oxide, oxyhalogenide, sulfide, oxysulfide, sulfate, oxysulfate, nitride, oxynitride, nitrate, oxynitrate, phosphide, phosphate, halophosphate, carbonate, silicate, halosilicate, oxysilicate, vanadate, molybdate, tungstenate, germanate or oxygermanate of the elements Li, Na, K, Rb, Mg, Ca, Sr, Se, Y, La, Ti, Zr, Hf, Nb, Ta, Zn, Gd, Lu, Al, Ga and In.

Preferred solid state compounds are Me(S, Se) (Me=Mg, Ca, Sr, Ba, Zn, Cd), Ln₂O₂S (Ln=Y, La, Gd, Lu), MgO, ZnO, Sc₂O₃, Y₂O₃, La₂O₃, Gd₂O₃, Lu₂O₃, TiO₂, ZrO₂, HfO₂, Nb₂O₅, Ta₂O₅, Al₂O₃, Ga₂O₃, In₂O₃, SiO₂, GeO₂, SnO₂, LnBO₃ (Ln=Sc, Y, La, Gd, Lu), Ln(BO₂)₃ (Ln=Sc, Y, La, Gd, Lu), Me₃(BO₃)₂ (Me=Mg, Ca, Sr), MeB₄O₇ (Me=Ca, Sr, Ba), Me₃Ln(BO₃)₃ (Me=Ca, Sr, Ba and Ln=Y, Gd, Lu), LnMgB₆O₁₀ (Ln=Y, La, Gd, Lu), LnAl₃(BO₃)₄ (Ln=Y, La, Gd, Lu), MeAl₂O₄ (Me=Mg, Ca, Sr, Ba), MeAl₁₂O₁₉ (Me=Ca, Sr, Ba), Me ₄Al₁₄O₂₅ (Me=Sr, Ba), Ln₃Me₅O₁₂ (Ln=Y, Gd, Lu and Me=Al, Ga, Sc), Me₃Al₂Si₃O12 (Me=Mg, Ca), Me₃Ln₂Ge₃O₁₂ (Ln=Y, Gd, Lu and Me=Sr, Ba), MeMgAl₁₀O₁₇ (Me=Ca, Sr), MeAlO₂ (Me=Li, Na. K), LiM₅O₈ (M=Al, Ga, In), LnMgAl₃₁O₁₉ (Ln=La, Gd), LnAlO₃ (Ln=Y, La, Gd, Lu), LnGaO₃ (Ln=La, Gd, Lu), LnInO₃ (Ln=La, Gd, Lu), Mg₂TiO₄, MeTiO₃ (Me=Mg, Ca, Sr, Ba), Ln₂Ti₂O₇ (Ln=Y, La, Gd, Lu), Ln₂Zr₂O₇ (Ln=Y, La, Gd, Lu), MeSiO₃ (Me=Ca, Sr, Ba), Me₂SiO₄ (Me=Ca, Sr, Ba), Me₃SiO₅ (Me=Ca, Sr, Ba), MeSi₂O₅ (Me=Sr, Ba), MeLi₂SiO₄ (Me=Ca, Sr), Ln₂SiO₅ (Ln=Al, Y, La, Gd, Lu), Ln₂Si₂O₇ (Ln=Y, La, Gd, Lu), NaLnSiO₄ (Ln=Al, Y, La, Gd, Lu), MeSi₂N₂O₂ (Me=Ca, Sr, Ba), MeAlSiN₃ (Me=Ca, Sr, Ba), Me₂Si₅N₃ (Me=Ca, Sr, Ba), Me₂Si₃Al₂N₆O₂ (Me=Ca, Sr, Ba), La₃Si₆N₁₁, LaSi₃N₅, MeYSi₄N₇ (Me=Sr, Ba), MeGe₂O₆ (Me=Ca, Sr, Ba), MeGe₄O₉ (Me=Ca, Sr, Ba), Mg₈Ge₂O₁₁ F₂, MeMO₄, (Me=Mg, Ca, Sr, Ba and M Mo, W), Ln₂MO₆ (M=Mo, W and Ln=Y, La, Gel, Lu), Ln₂M₂O₉ (M=Mo, W and Ln=Y, La, Gd, Lu), Ln₂M₃O₁₂ (M=Mo, W and Ln=Y, La, Gd, Lu), MeLnM₂O₈ (Me=Li, Na, K, Rb and M=Mo, W and Ln=V, La, Gd, Lu), LnMO₄ (M=P, V, Nb, Ta and Ln=Sc, Y, La, Gd, Lu), Me₂M₂O₇ (M=P, V, Nb, Ta and Me=Ca, Sr, Ba) or suitable mixed crystals of these compounds with each other.

The pigments can be used in a manner known in the art as security pigments according to the present invention, for example, in the form of the compounds, in a matrix or applied to a carrier material, in the form of a varnish, paint, suspension, dispersion, colloidal solution, ink, paste etc.

For performing the method according to the invention, first an emission spectrum of the luminescent pigment is generated. Generating the emission spectrum can be done in any way known to a person of skill in the art, for example, through a discrete excitation energy and/or temperature. Generating the emission spectrum should be done under defined excitation conditions. Preferably, the employed security element contains one or several luminescent pigments whose emission spectrum/emission spectra changes/change as a function of the energy of the exciting electromagnetic radiation, the temperature, the time lapsed after the action of the excitation pulse or the ambient pressure.

In a preferred embodiment, at least 2 emission spectra are recorded wherein these spectra can be obtained with excitation pulses that differ from each other and/or as a function of time, i.e., time intervals from action of the excitation pulse, and/or change of the ambient pressure. This embodiment encompasses the configuration that 2 different emission spectra are generated by one luminescent pigment or 1 or several emission spectra are generated by 2 or more luminescent pigments.

In a possible embodiment of the present invention, the employed luminescent pigment is introduced into a UV-transparent matrix. This method has the advantage that a UV radiation source can be used for the detection of the security pigments. Preferably, as a UV-transparent matrix a photonic matrix is used, for example, an inverse opal, such as an inverse SiO₂ opal.

The generated emission spectrum or spectra are compared in the second method step with the predetermined spectrum / spectra of the luminescent pigment contained in the security element. The generated emission spectrum is compared with the known spectrum of the respective luminescent pigment under the same excitation conditions. If the spectra are identical, the authenticity of the identified object can be confirmed. Recording and comparing the generated emission spectrum with the predetermined spectrum is done preferably automatically. For this purpose, the generated emission spectrum is recorded digitally. Afterwards, the digitally recorded spectrum can be compared with the predetermined spectrum of the luminescent pigment contained in the security element. The comparison can occur in different ways. When the identifying product or the luminescent pigment that is used for this product is known, the generated spectrum can be compared directly with the corresponding predetermined spectrum. Products whose origin is not known can also be identified with the method according to the invention, In such a situation, one or several emission spectra are generated. This spectrum or these spectra are compared with known spectra and by means of the comparison a correlation to a certain product can be realized.

In order to make easier the comparison of the generated spectra with the predetermined spectra, the predetermined spectra are saved preferably in an electronic database, and the generated spectra can be compared by suitable electronic media and data processing programs to the spectra saved in the database. Comparing the spectra can also be done by hand.

In a possible configuration, an emission spectrum is first generated; it is then compared to the known spectra that are optionally saved in the database. When a match of the spectra is determined, a second spectrum, different from the first spectrum, can be generated and, for confirmation of the result, can be compared to the predetermined second spectrum.

An extremely high variability of the emission spectrum of the security element and therefore a high uniqueness for a plurality of different products can be achieved, for example, for individual or a combination of two or several measures:
a) Use of at least two luminescent pigments, wherein at least one of the two pigments has an emission spectrum whose intensity and optionally also spectral energy distribution depends on the excitation wavelength (FIGS. 1 and 4). The demanded strong dependence of the intensity means that the excitation spectrum must be strongly structured, as for example that of Tb₂W₃O₁₂ (FIG. 5).
b) Use of at least one luminescent pigment which comprises at least two kinds of luminescence centers, wherein the two luminescence centers are introduced by doping, as for example in YBO₃:Ce,Tb or in Y₃Al₅O₁₂:Ce,Fe. The resulting emission spectra of such luminescent substances naturally depend on the concentration ratio of both doping ions (FIGS. 2 and 6). Accordingly, one obtains luminescent pigments whose emission spectra depend on the excitation wavelength and, in addition, also on the temperature, because the energy transfer between the different activator ions is dependent on temperature (FIG. 3)
c) Use of at least one luminescent pigment which shows prolonged luminescence (phosphorescence) after the excitation pulse (FIG. 7), as for example the luminescent pigment. Sr₄Al₁₄O₂₅:Eu,Dy. Accordingly, the emission spectrum of the security element has a time-dependent component which is moreover also dependent on the excitation wavelength.
d) Use of at least one luminescent pigment that exhibits luminescence as a result of a pressure change mechanical luminescence or sonoluminescence) or changes its emission spectrum, i.e., exhibits luminescence spectra that are dependent on pressure.
e) Use of at least one luminescent pigment which is characterized in that it contains a bistable redox activator, i.e., two oxidation stages. In consequence, the emission spectrum as well as the decay behavior depends very strongly on the excitation wavelength. In addition, the relative proportion of both oxidation stages is strongly dependent on the preparation of the pigment; this requires an exact knowledge of the preparation condition for imitation. Bistable redox activators include Cr^{3+/4+}, Mn^{2+/4+}, Pb^{2+/4+}, Ce^{3+/4+}, Pr^{3+/4+}, Sm^{2+/3°}, Eu^{2+/3+}, Tm^{2+/3+} as well as Yb^{2+/3+} (FIGS. 9 to 12).
f) Use of at least one luminescent pigment which emits radiation (FIG. 8) exclusively in the UV or in the NIR range; this enables a concealed security element.
g) Use of at least one luminescent pigment which exhibits upon excitation in the NIR range visible or UV luminescence, i.e. up conversion. Suitable up converters are, e.g., NaYF₄:Yb,Pr, NaNiF₄:Yb,Tm or NaYF₄:Yb,Er (FIG. 13).

An essential feature of the employed security element or the luminescent pigments contained therein is that these pigments generate a specific emission spectrum after suitable excitation which can serve as an optical fingerprint. Preferably, such luminescent pigments are used whose emission spectra change as a function of the spectral-dependent excitation energy, the temperature, the time after action of the excitation pulse and/or the ambient pressure. In a possible embodiment of the present invention, the excitation energy is modulated for generating the emission spectrum wherein a change of the emission spectrum of the security element goes hand in hand with this modulation. In other embodiments of the present invention the generation of the emission spectrum can be based on the temporally modulated excitation or emission of the luminescent pigments and/or on the thermally modulated and/or pressure-modulated excitation or emission of luminescent pigments. In a particularly preferred embodiment, it is possible to modulate one or several excitation form(s) so that the obtained emission spectrum is based on a combination of emission of the luminescent pigments that has been modulated by temporal, thermal, pressure-dependent and/or energy-dependent (as by radiation wavelength) excitation.

The detection of the security element occurs preferably through a detection system which operates with inorganic or organic LEDs as a primary source of light. The use of LEDs in a system for detection of or characterization of luminescent substances has been claimed for the first time in 1997 [9]. The LEDs can emit in the UV (210-400 nm), in the visible (400-700 nm) or in the near infrared range (700-1,800 nm). Optionally, the detection system can comprise also two LEDs or a polychromatic LED array, so that the spectrum of the primary source of light is variably or even freely tunable.

In case of a temporally modulated detection of the emission spectra of the security element according to the invention, a pulse generator is required and a detection system that is able to record emission spectra as a function of the time after the excitation pulse (FIG. 13).

In case of a thermally modulated detection of the emission spectrum of the security element according to the invention, the product with the security element is introduced into a temperature-controlled chamber or the information carrier is placed onto a heatable sample holder and the emission spectrum is recorded at e,g, 25° C. and afterwards at 50° C. or even higher temperatures.

Another aspect of the present invention is a security element with concealed or open security feature for its identification which contains one or several inorganic luminescent pigments, wherein for each luminescent pigment at least one emission spectrum can be generated as a function of the spectral excitation energy, the temperature, the time after action of the excitation pulse or the ambient pressure, with the proviso that when only one luminescent pigment is included, at least two emission spectra different from each other can be generated.

This means that when the security element X contains inorganic luminescent pigments with X≧1 and X═N−1 which originate from a set with N elements and each element represents a luminescent pigment with an emission spectrum that is different from the spectra of all other luminescent pigments of the quantity, (N!)/[X!(N—X)!)] spectrally different security elements are provided in this manner. Such a configuration enables ascertaining the original origin of a product with a high level of certainty.

In a preferred embodiment the security element according to the invention contains at least two or even several luminescent pigments wherein preferably at least one of the contained luminescent pigments exhibits an emission spectrum which changes as a function of the spectral excitation energy, the temperature, the time after the excitation pulse, and the ambient pressure.

Another aspect of the present invention is the use of the security element for identifying products, for example, plastics (elastomers, thermoplastic materials, thermoset materials, foamed plastics, resins, building materials, natural rubber and rubber materials, color varnishes, raw paper materials, specialty glasses, ceramic products and ceramic materials, explosives, adhesives, papers including documents of value and security documents, like banknotes and securities, credit cards, cash cards, identification cards, passport documents, charge cards, documents, stamps, tickets, audio and video media, packaging, synthetic and natural fibers, fabrics and laid fabrics (nonwovens), wood, surface coatings, ceramics, plants and animals as well as products made therefrom, including fibers, leather, fabrics and laid fabrics, pharmaceutical products and devices etc. In summarizing the above, by using the security element according to the invention and the method according to the invention described above, any material, device and apparatus can be provided with a security element and identified accordingly,

The security element, i.e. the inorganic luminescent pigment(s) can be incorporated into or applied in a manner known in the art to the materials to be marked.

The security element according to the invention can take on even other functions in addition to the identification of the product. After identification of the security element it is possible to not only check the product for authenticity, the security element can also take on the function of a specification plate As soon as it has been determined by checking the emission spectrum that the object to be identified is an original product, i.e. no forgery, information in regard to the production, ingredients, warranty or expiration data, service information, operating instructions, including information about the product type and batch can be obtained by means of linking the emission spectrum with further product data.

The method according to the invention can be combined easily with existing methods for product identification, such as bar code, DataGrid, DataMatrix, holograms, infrared features, QR code, CDP, RFID, and/or markings applied on the packaging for the purpose of storing production and transport data

Another aspect of the present invention is a device for identifying an obⱼect which encompasses
Means for generating an excitation pulse,
A detector for recording an emission spectrum.

As further means, the device according to the invention can have means for reproducing the emission spectrum and means for comparing the recorded emission spectrum with a predetermined spectrum or can be connected to suitable devices provided with these means by means of suitable data lines and data connections.

With the device according to the invention it is possible to identify an object in an easy way, for example, check its authenticity to confirm that it is indeed a so-called original product. With the device according to the invention an excitation pulse is first generated that produces an emission spectrum in case of the presence of luminescent pigments. To be able to record the generated emission spectrum, the device comprises a detector. With the aid of the detector the emission spectrum is recorded and, if necessary, saved immediately in the device. It is also possible that the recorded spectrum is transferred by means of suitable data transfer systems to an external server or suitable external device and is saved therein, if necessary.

The recorded spectrum can be reproduced directly by the device according to the invention, the latter containing means for reproducing the emission spectrum. It is also possible to reproduce the recorded spectrum on an external device that is connected by suitable data lines or data connections.

In the next step the recorded spectrum is either compared with, provided that the device according to the invention has suitable means, to a predetermined emission spectrum. In another configuration, it is also possible that the comparison of the recorded emission spectrum with the predetermined spectrum is not carried out on the device according to the invention, but on an external device which comprises, e.g., a suitable database of predetermined emission spectra, and is connected with such a database. In such a configuration, the notification whether the object is identified as “authentic” or whether it is a different object than the expected one, can be realized by an appropriate communication from the external device to the device according to the invention.

In another possible embodiment, the recorded emission spectrum can also be saved on a suitable storage medium and transferred to another device which reproduces the emission spectrum or compares it internally directly to a predetermined emission spectrum. Nevertheless, the transfer via data lines is preferred,

### EXAMPLES

In the following, the invention will be explained with the aid of six embodiments in more detail, wherein the security level with respect to copy protection increases from example 1 to example 6.
1. A security element consisting of two luminescent pigments, wherein both pigments are comprised of Ln₃Me₅O₁₂ garnet host lattice (Ln=Y, Gd, Lu and Me=Al, Ga, Sc, Si, Mg) each doped with one of the abovementioned luminescent ions. When exclusively Y₃Al₅O₁₂ doped in each case with a trivalent lanthanoide ion is used, 45 possible combinations according to the following Table are obtained upon use of the same amounts of both pigments

TABLE 1
Representation of 45 possible combinations when using two YAG luminescent
substances, doped in each case with different activator ions, for the security element.

| Y₃Al₅O₁₂ | Pr³⁺ | Nd³⁺ | Sm³⁺ | Eu³⁺ | Tb³⁺ | Dy³⁺ | Ho³⁺ | Er³⁺ | Tm³⁺ | Yb³⁺ |
|---|---|---|---|---|---|---|---|---|---|---|
| Pr³⁺ | − | + | + | + | + | + | + | + | + | + |
| Nd³⁺ | + | − | + | + | + | + | + | + | + | + |
| Sm³⁺ | + | + | − | + | + | + | + | + | + | + |
| Eu³⁺ | + | + | + | − | + | + | + | + | + | + |
| Tb³⁺ | + | + | + | + | − | + | + | + | + | + |
| Dy³⁺ | + | + | + | + | + | − | + | + | + | + |
| Ho³⁺ | + | + | + | + | + | + | − | + | + | + |
| Er³⁺ | + | + | + | + | + | + | + | − | + | + |
| Tm³⁺ | + | + | + | + | + | + | + | + | − | + |
| Yb³⁺ | + | + | + | + | + | + | + | + | + | − |

When also the quantitative ratios are varied in steps of 5%, according to 5-95, 10-90, 15-85 to 95-5, one obtains additional 19 different emission spectra and therefore a total of 855 variants. The number can be increased naturally further when three or even more luminescent pigments are used, The excitation of the security element is realized with a discharge lamp and/or with an LED which emits at the standard wavelengths of 254 or 266 nm.

A security element consisting of X inorganic luminescent pigments (with X=10−1) which originate from a set with 10 luminescent pigments and wherein this set contains, for example, the luminescent pigments Y₃Al₅O₁₂:Pr, Y₃Al₅O₁₂:Nd, Y₃Al₅O₁₂:Sm, YₐAl₅O₁₂:Eu, Y₃Al₅O₁₂:Tb, Y₃Al₅O₁₂:Dy, Y₃Al₅O₁₂:Ho, Y₃Al₅O₁₂. Er, Y₃Al₅O₁₂:Tm, and Y₃Al₅O₁₂:Yb. The emission spectra of these luminescent pigments are so different that they can be discriminated with a simple optical spectrometer. Therefore, a total of 1,000 spectrally different security elements are provided. The excitation of the security elements is realized with a discharge lamp and/or with an LED which emits at the standard wavelengths of 254 or 366 nm,

A security element with two luminescent pigments wherein one of the two pigments exhibits prolonged luminescence (phosphorescence). While the first pigment is Y₃Al₅O₁₂:Ln (Ln =Ce, Pr, Nd, Sm, Eu, Tb, Dy, Ho, Er, Tm, Yb) with short decay time, the second pigment originates from the group of the phosphorescent pigments, in particular from the group SrAl₂O₄:Eu,Dy, CaAl₂O₄:Eu, Nd, Sr₄Al₁₄O₂₅:Eu,Dy, Sr₂MgSi₂O₇: Eu, Dy. Sr₃MgSi₂O₈: Eu, Dy, CaMgSi₂O₆:Eu,Dy, Ba₃MgSi₂O₈Eu,Dy, BaMg₂Al₆Si₉O₃₀:Eu, Dy, Sr₂Al₂SiO₇:Eu,Dy, SrAl₁₀SiO₂₀:Eu, HoCaAl₂Si₂O₈:Eu,Dy, CaAl₂Si3O₈:Eu,Pr, Sr₂SiO₄:Eu,Dy, Sr₂ZnSi₂O₇:Eu,Dy, CaS:Eu,Tm, CaGa₂S₄:Eu,Ho, CaGa₂S₄:Eu,Ce, Sr₂P₂O₇:Eu,Y, Ca₂P₂O₇:Eu,Y, Ca₂SiS₄:Eu,Nd or Ca₂MgSi₂O₇:Eu,Tb, which exhibit luminescence for several minutes or even hours. In this way, the time-dependent behavior of the emission can be employed for detecting authenticity of the product. The excitation of the security element is also realized here with a discharge lamp and/or with an LED which emits at the standard wavelengths 254 or 366 nm.
4. A security element with two luminescent pigments, wherein one of the two pigments contains a bistable redox activator. While the first pigment is a sesquioxide that is doped with Eu³⁺, Pr³⁺, or Cr³⁺, i.e., is Al₂O₃, In₂O₃, Y₂O₃, Gd₂O₃, or Lu₂O₃, the second pigment is an aluminate which is doped with Sm²⁺ and Sm³⁺, Sr₄Al_{13.5}B_{0.5}O₁₂:Sm. The excitation of the security element occurs here, on the one hand, with a discharge lamp and/or an LED which emits at the standard wavelengths of 254 or 366 nm and, on the other hand, with a discharge lamp and/or an LED which emits at 400 or 550 nm.
5. A concealed security element with two luminescent pigments, wherein one of the two pigments emits radiation only in the UV or only in the IR range so that it is invisible to the human eye. The excitation of the security element occurs here with a discharge lamp and/or an LED which emits in a narrow band at 250 to 550 nm.
6. A concealed security element with two luminescent pigments, wherein the first one of the two pigments emits radiation only in the UV range and the second one of the two pigments emits radiation only in the IR range so that both remain invisible to the human eye. The excitation of the security element occurs here with a discharge lamp and/or an LED which emits in a narrow band at 250 to 550 nm.

Application in Practice

Identification of a medicament, the luminescent pigment according to FIG. 1 is applied on a medicament A so as to be invisible to the human eye.

For identification, an emission spectrum is recorded by means of a hand device, the recorded spectrum is compared with the spectra of the database which contains all spectra which were generated for the respective products, respectively. When a match is found, the identity of the medicament is confirmed.

If the spectrum cannot be matched unambiguously, another spectrum can be recorded, for example, at another excitation wavelength and a comparison of the second spectrum or of both spectra is carried out via the database.

In FIG. 14 a flow chart in regard to the possible use of the security element according to the invention for marking a medicament is illustrated.

The security element can be used for marking any pharmaceutical preparations, like coated tablets, capsules, compressed solids, pellets, plasters, tablets, suppositories of all kinds. In preparations that cannot be marked individually, the security element is preferably incorporated (e.g., in case of powders) or applied to their packaging (e.g., clear liquids).

To ascertain the authenticity of the medicament and to identify the medicament itself, the security element or the tablet is checked with a suitable device which emits radiation with a defined wavelength and records the emission spectrum emitted by the security element. This spectrum is sent, usually via mobile devices, to a database. In the database the transmitted spectrum is compared. Provided that this spectrum with the accompanying data concerning the active ingredient, manufacturer or similar data is matched, the database sends positive feedback and a second measurement at a defined excitation wavelength, preferably different from the wavelength of the first measurement, is carried out. The emission spectrum of the second measurement is also transferred to the database and is compared with the spectra available therein. If both emission spectra can be correlated with the same product, the database acknowledges that the medicament has been identified and confirms the authenticity of the medicament.

At the same time with the authentication of the medicament, it is possible to confirm to the customer, i.e to the patient, the drugstore and/or the hospital, that the product in question is an original medicament.

Provided that the authenticity of the medicament has been confirmed, additional data which are saved in the database can be transmitted to the customer / user, such as date of manufacture, batch number, expiration date, etc.

Performing one measurement offers a very high success probability, the error rate is about 1:10,000. When two measurements are carried out now, the error rate of the first measurement is further reduced by the factor 1:10,000 so that with two measurements the error probability is 1:10⁶.

### DESCRIPTION OF THE PICTURES AND DRAWINGS

FIG. 1 shows the emission spectra of YBO₃:Ce at the excitation wavelengths of 254, 300 and 366 nm.

FIG. 2 shows the emission spectra of YBO₃:Ce:Fb for three different terbium concentrations at the excitation wavelength of 360 nm.

FIG. 3 shows the emission spectra of YBO₃:Ce,Tb as a function of the temperature.

FIG. 4 shows the emission spectra of Tb₂W₃O₁₂ at the excitation wavelengths of 330, 360 and 400 nm.

FIG. 5 shows the excitation spectrum of Tb₂W₃O₁₂for the 544 nm emission line,

FIG. 6 shows the emission spectra of Y₃Al₅O₁₂:Ce,Fe with the excitation wavelengths of 254 and 450 nm.

FIG. 7 shows the decay curves of Sr₄Al₁₄O₂₅:Eu at the excitation wavelengths of 250, 360 and 400 nm,

FIG. 8 shows the emission spectra of KMgF₃:Eu at the excitation wavelengths of 254, 300 and 340 nm.

FIG. 9 shows the emission spectra of Sr₄Al_{13.5}B_{0.5}O₂₅:Sm^{2+/3+} at the excitation wavelengths of 254, 399 and 450 nm.

FIG. 10 shows the excitation spectra of Sr₄Al_{13.5}B_{0.5}O₂₅:Sm^{2+/3+} for the emission wavelengths of 598 and 750 nm.

FIG. 11 shows the emission spectra of SrAl₁₂O₁₉:Eu^{2+/3+} at the excitation wavelength of 270 nm.

FIG. 12 shows the emission spectra of NaYF₄:Yb,Er at the excitation wavelength of 980 nm.

FIG. 13 shows the schematic configuration of the detection system according to the invention.

FIG. 14 shows a flow chart with regard to a possible application of the security element.

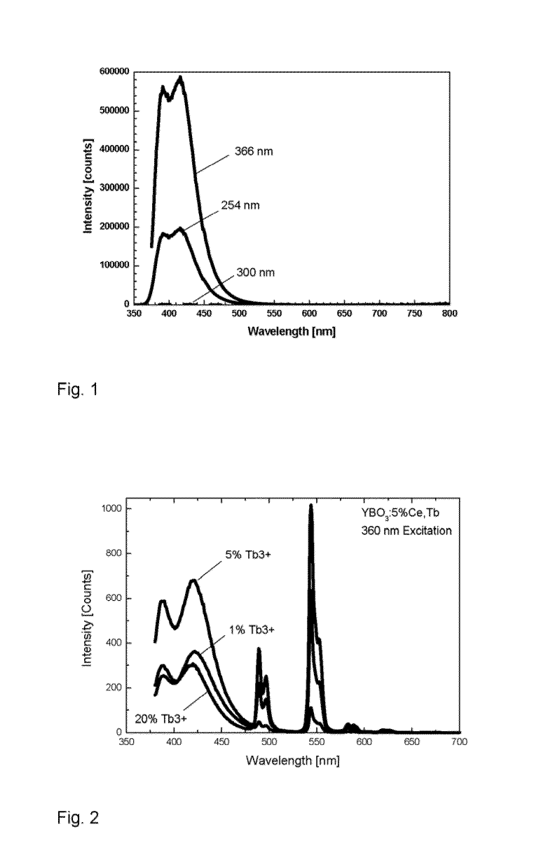

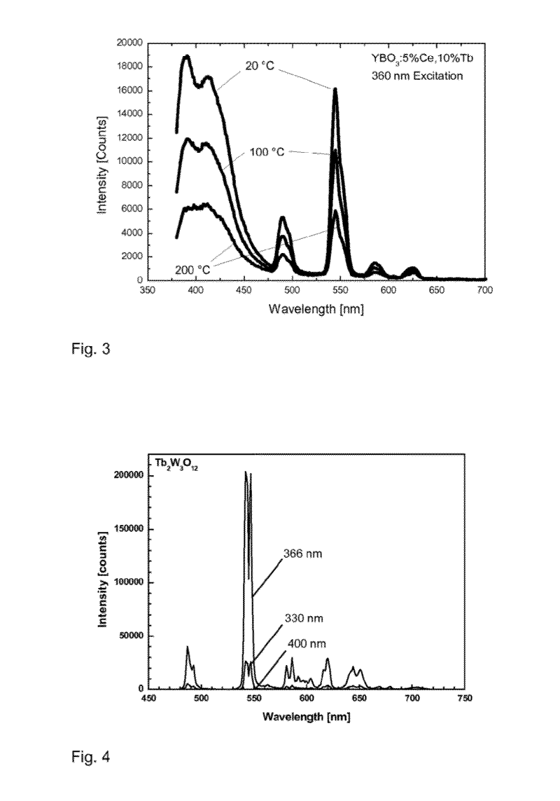

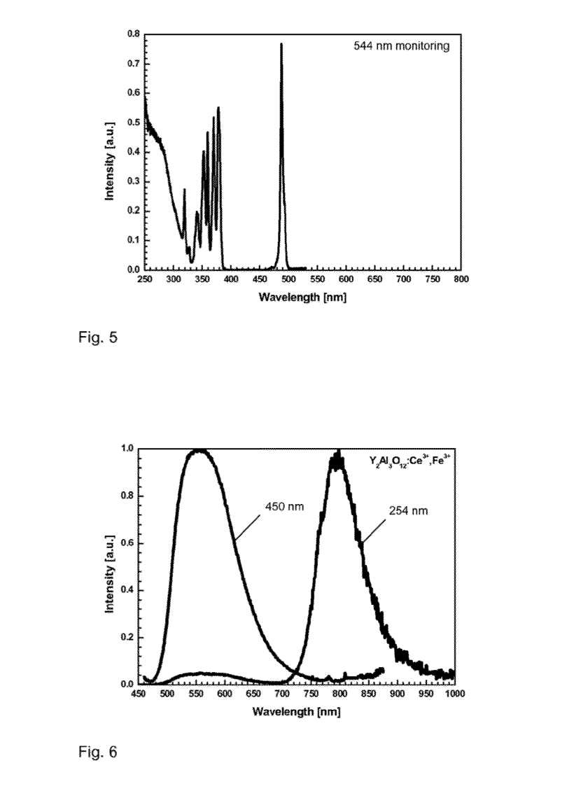

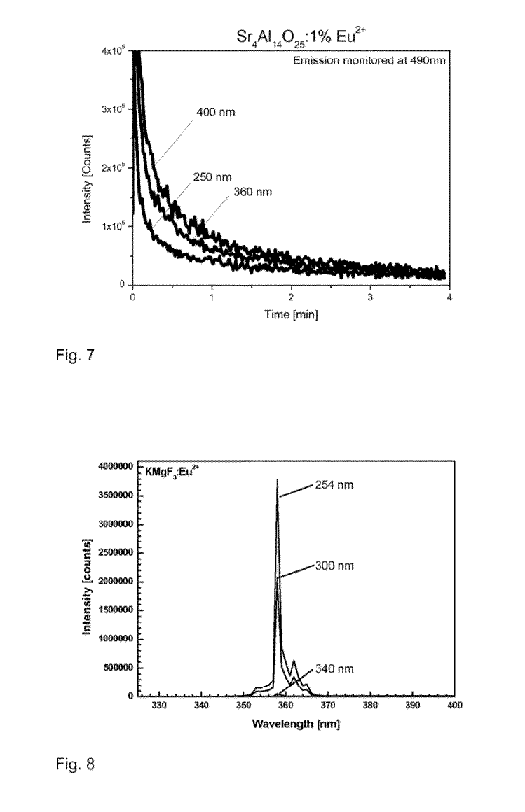

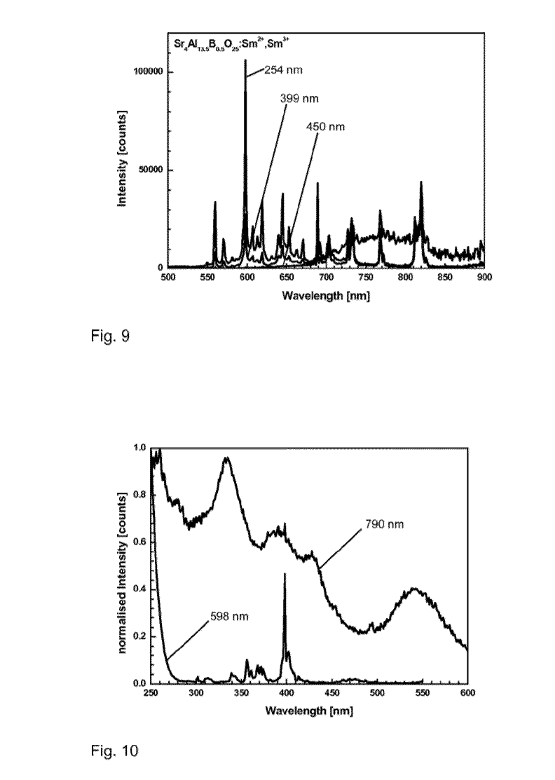

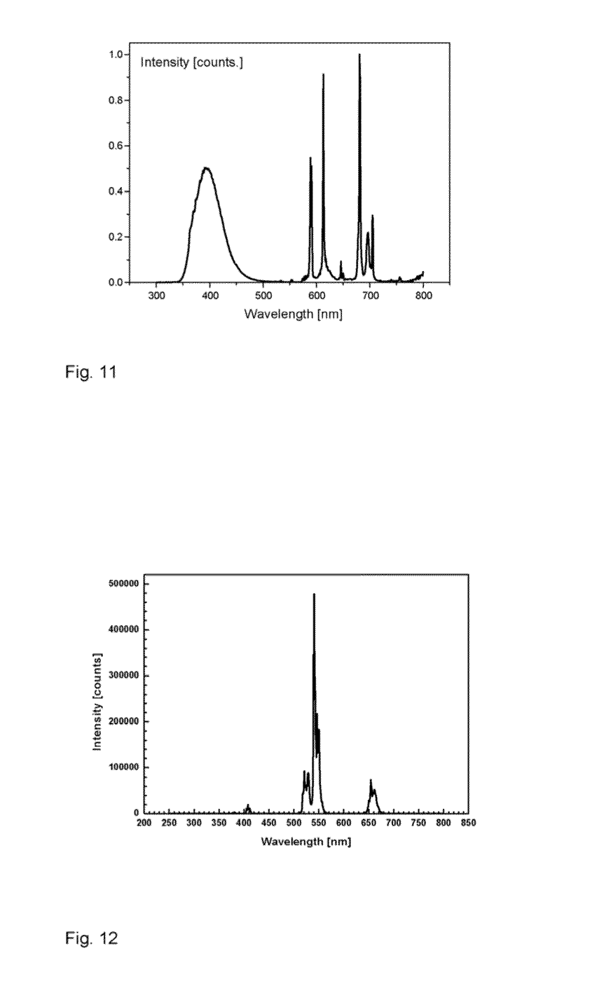

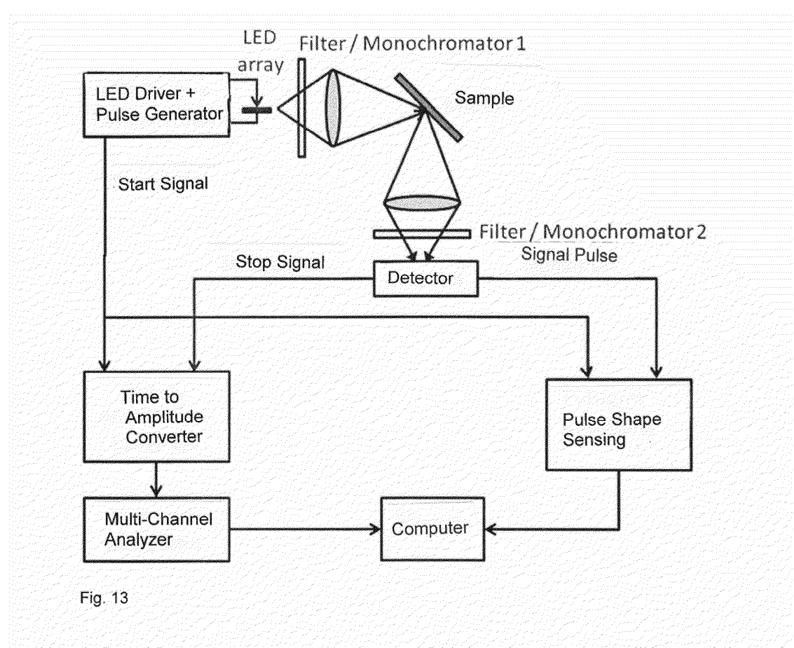

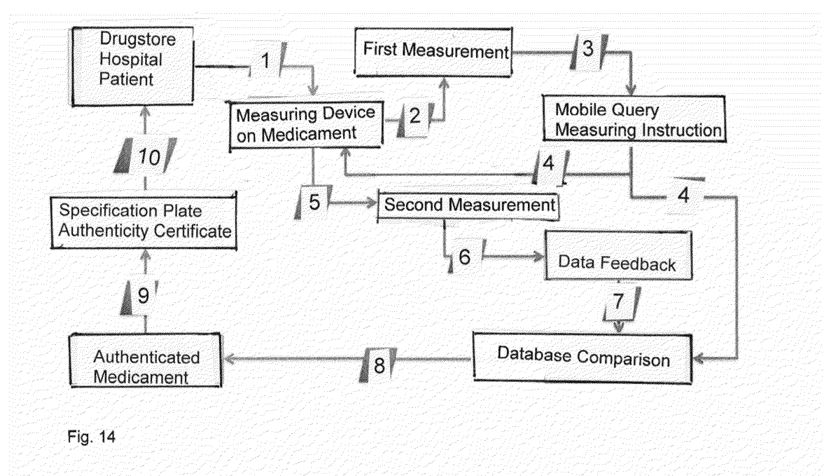

### PATENT LITERATURE

[1] WO 2009/071167

[2] DE 19804032

[3] EP 1237128

[4] WO2004/081125

[5] US 2008/315574 ®WO 2006/029431

[6] EP 1 241 021 A2

[7] DE 198 36 813 A1

[8] DE 202 21 282 U1

[9] EP 1 844 945

What is claimed is:

1. Method for identifying an object, wherein the object comprises a security element which contains one or several inorganic luminescent pigments, whose emission spectrum/emission spectra change as a function of the energy of the exciting electromagnetic radiation, the temperature, the time after action of the excitation pulse or the ambient pressure, the method comprising the steps of
generating at least 2 emission spectra of the luminescent pigment, wherein these spectra can be obtained with excitation pulses that are different from each other and/or as a function of the time, i.e., time intervals from action of the excitation pulse and/or change of the ambient pressure,
comparing the obtained emission spectra with spectra predetermined for the luminescent pigment.

2. (canceled)

3. (canceled)

4. Method according to claim 1, wherein the luminescent pigment is an inorganic solid state compound, that contains one or several luminescent ions from the group of In⁺, Sn²⁺, Pb²⁺, Sb³⁺, Bi³⁺, Ce³⁺, Ce⁴⁺, Pr³⁺, Nd³⁺, Sm²⁺, Sm³⁺, Eu²⁺, Eu³⁺, Gd³⁺, Tb³⁺, Dy³⁺, Ho³⁺, Er³⁺, Tm²⁺, Tm³⁺, Yb²⁺, Yb³⁺, Ti³⁺, V²⁺, V³⁺, V⁴⁺, Cr³⁺, Mn²⁺, Mn³⁺, Mn⁴⁺, Fe³⁺, Fe⁴⁺, Fe⁵⁺, Co³⁺, Co⁴⁺, Ni²⁺, Cu⁺, Ru²⁺, Ru³⁺, Pd²⁺, Ag⁺, Ir³⁺, Pt²⁺ and Au⁺.

5. Method according to claim 1, wherein the luminescent pigment is a binary, ternary or quaternary halogenide, oxide, oxyhalogenide, sulfide, oxysulfide, sulfate, oxysulfate, selenide, nitride, oxynitnde, nitrate, oxynitrate, phosphide, phosphate, carbonate, silicate, oxysilicate, vanadate, molybdate, tungstenate, germanate or oxygermanate of the elements Li, Na, K, Rb, Mg, Ca, Sr, Sc, Y, La, Ti, Zr, Hf, Nb, Ta, Zn, Gd, Lu, Al, Ga and In.

6. Method according to claim 1, wherein the inorganic luminescent pigment is introduced into a UV-transparent matrix.

7. Method according to claim 6, wherein the UV-transparent matrix is a photonic matrix, such as an inverse opal.

8. Method according to claim 1. wherein the luminescent pigment has a mean particle size between 1 nm and 1,000 μm.

9. Method according to claim 1, wherein the change of the emission spectrum of the security element is based on the modulation of the excitation energy and/or a temporally modulated excitation or emission and/or a thermally modulated excitation or emission and/or a pressure-modulated excitation or emission of the luminescent pigments.

10. Method according to claim 1, based on one or several combinations of the modulated excitation or emission by the emission spectrum, by temporally, thermally, pressure-based or excitation energy-based modulated excitation or emission of luminescent pigments.

11. Security element with concealed or open security feature for its identification, which contains one or several inorganic luminescent pigments, wherein for each luminescent pigment at least one emission spectrum can be generated as a function of the spectral excitation energy, the temperature, the time after action of the excitation pulse or the ambient pressure, wherein at least two emission spectra different from each other are generated.

12. Security element according to claim 11 in which at least two luminescent pigments are used.

13. Use of the security element according to claim 11 for the identification of products.

14. Use according to claim 13, wherein the products are plastics, building materials, rubber materials, color varnishes, raw paper materials, specialty glasses, ceramic products and ceramic materials, explosives, adhesives, papers including documents of value and security documents such a banknotes and securities, credit cards, cash cards, identification cards, passport documents, charge cards, documents, stamps, tickets, audio and video media, packaging, cast metal, aluminum, chemicals, glass, textiles, synthetic and natural fibers, fabrics and laid fabrics (nonwovens), wood, surface coatings, ceramics, plants and animals, as well as products made therefrom, including fibers, leather, fabrics and laid fabrics, electronics, composite materials, fuels and oils, sinter materials, cosmetics, pharmaceutical products and devices.

15. Device for identifying an object which comprises
means for generating an excitation pulse,
a detector for recording an emission spectrum.

16. Device according to claim 15, wherein it has means for reproducing the emission spectrum.

17. Device according to claim 15, wherein it has means for comparing the recorded emission spectrum with a predetermined spectrum.

18. Device according to claim 15, wherein it is connected with a device which has means for reproducing the emission spectrum and/or means for comparing the recorded emission spectrum with a predetermined spectrum.
